(19) United States
(12) Patent Application Publication
(10) Pub. No.: US 2025/0062052 A1
(43) Pub. Date: Feb. 20, 2025

(54) FABRIC WET POWER GENERATION MATERIAL BASED ON MOLYBDENUM DISULFIDE, AND PREPARATION METHOD AND USE THEREFOR

(71) Applicant: SOOCHOW UNIVERSITY, Suzhou (CN)

(72) Inventors: Min ZHENG, Suzhou (CN); Yuanming CAO, Suzhou (CN); Mi ZHENG, Suzhou (CN); Zuoshan WANG, Suzhou (CN)

(21) Appl. No.: 18/724,181

(22) PCT Filed: Feb. 24, 2023
(86) PCT No.: PCT/CN2023/078271

§ 371 Date: Jun. 25, 2024

(30) Foreign Application Priority Data
Dec. 26, 2021 (CN) 202111606733.6

(51) Int. Cl. H01B 5/12; C01G 39/00

(52) U.S. Cl. CPC H01B 5/12; C01G 39/00; C01P 2002/72; C01P 2004/20

(57) ABSTRACT

A fabric wet power generation material based on molybdenum disulfide and a preparation method and use therefor. Taking molybdenum disulfide as a base material, an in-situ grown MoS₂ carbonized fabric and a MoS₂-based conductive cellulose fiber fabric are prepared by using a hydrothermal method. Then the two fabrics are superposed to form a double-potential layer, so that under a wet condition, the textile uses water evaporation as a driving force, and the water molecules migrate in the double-conductive layers to generate a current, so as to achieve self-power generation, and the fabric wet power generation material is prepared. The fabric wet power generation material provided by the present invention uses metal as a negative electrode, and after being packaged, the fabric wet power generation material is applied to a wet power generation apparatus. In the fabric wet power generation material provided by the present invention, a transition metal disulfide nanomaterial having a three-dimensional micro-channel structure is constructed on the nano scale, and the structure ensures a large moisture conduction conductivity; meanwhile, a large number of pore channels existing in the three-dimensional structure can shorten the ion transmission distance, so that the power generation performance is improved, and there are advantages of being simple and rapid in preparation process and high in yield, and being beneficial to industrial production and application in the field of flexible intelligent textile.

### FIELD OF THE INVENTION

The present invention relates to a fabric wet power generation material based on molybdenum disulfide textiles for self-power generation, a preparation method and an application therefor, and belongs to the technical field of material preparation and application.

### BACKGROUND OF THE INVENTION

While using biomass materials as a power generation medium to develop a sustainable, biocompatible, biodegradable, and cleaner biological nano generator, it is expected to obtain a low-cost and high-efficiency electric energy collection strategy from humid air: electric energy can be conveniently accumulated and stored for use by a small-sized and wearable electronic device; and electricity generation can also be driven through some physiological processes, such as plant transpiration and human respiration, and in turn are used for passive health sensing (e.g. respiratory frequency and intensity), etc.

The bio-based moisture power generation device has the advantages such as being simple, effective, renewable, low in cost, high in biocompatibility, biodegradable and the like, and has potential value in the fields of new energy, biomedicine, miniature wearable electronic devices and the like; Moreover, the biological nanofibers can be prepared by using agriculture, forestry and fishery waste as raw materials, so that the problems of energy shortage and environmental pollution can be solved to a certain extent. The biomass material can be effectively utilized as a clean energy source to fully realize its own value and meeting the current social development requirements for energy and environment.

In recent years, molybdenum disulfide (MoS₂), a Transition-Metal Dichalcogenides (TMDCs), as an emerging nano two-dimensional material, has received widespread attention in the field of electrochemical energy storage and conversion because of its relatively large specific surface area, rich surface/edge atoms and various physical properties. In addition, the Van der Waals force of layered molybdenum disulfide enables transition metal disulfide nanomaterials to be easily adsorbed onto attachments, so that its excellent performance can be transferred.

Prior to the present invention, it is reported that by using liquid-phase exfoliation method to prepare a two-dimensional molybdenum disulfide nanosheet, and using a method of vacuum filtration to deposit them on cellulose paper, implanting metal electrodes, a wet-induced power generation thin film is obtained. Tests show that the power output can reach 40 μW/cm³ (see literature: D. He et al., Electricity generation from phase-engineered flexible MoS₂ nanosheets under moisture. Nano Energy 2021, 81, 105630.) However, the challenge of wet power generation equipment lies in the power generation capacity and the actual demand for large-scale production.

### SUMMARY OF THE INVENTION

In order to overcome the shortcomings of the existing wet-induced power generation technology in the aspects of power generation and large-area preparation, the present invention provides a wet power generation flexible material with high power generation efficiency, large power generation power, long duration, large-area preparation, simple process and low cost, and a preparation method and an application thereof.

The technical solution for achieving the purpose of the present invention is to provide a preparation method of a fabric wet power generation material based on molybdenum disulfide, comprising the following steps:

(1) Washing and drying the silk fabric, and carbonizing it in an argon atmosphere at a temperature of 900-1500° C. for 90-180 minutes; dissolving anhydrous sodium molybdate in deionized water, adding L-cysteine powder into the anhydrous sodium molybdate solution according to a molar ratio of anhydrous sodium molybdate to L-cysteine of 1:2.5-1:3.0, and fully dissolving to obtain a mixed solution; adding the carbonized silk fabric into the mixed solution, stirring for 1-2 h, then placing the silk fabric in a high-pressure reactor, reacting for 10-24 h at a temperature of 200-250° C. and a pressure of 1-4 MPa, and washing and drying to obtain an MoS₂ in-situ grown carbonized fabric;

(2) Adding bulk MoS₂ to the n-butyllithium solution according to a mass ratio of 15:1-18:1, and dealing with water bath exfoliation treatment for 10-15 h under an argon atmosphere at a temperature of 60-80° C., then performing centrifugal separation; washing with n-hexane and dispersing the washed powder in water at a concentration of 0.5-5 mg/mL, performing ultrasonic dispersion treatment for 1-2 h, and then performing centrifugal separation at a rotational speed of 2000-3000 r/min to obtain a MoS₂ sheet layer material, which is then configured to be an MoS₂ aqueous dispersion of 0.01-0 03 M; placing the cellulose fiber fabric in the MoS₂ aqueous dispersion for 10-60 min, keeping the liquid rate at 80-120% by rolling, baking for 3-15 min at a temperature of 130-150° C., spin-coating a polyacrylamide solution at a rotational speed of 2000-5000 r/min, and drying to obtain a MoS₂-based conductive cellulose fiber fabric;

(3) superposing the MoS₂ in-situ grown carbonized fabric obtained in step (1) and the MoS₂-based conductive cellulose fiber fabric obtained in step (2) to obtain a fabric wet power generation material based on molybdenum disulfide.

In the preparation method of a fabric wet power generation material based on molybdenum disulfide in present invention, in step (1), the mass ratio of the carbonized silk fabric to the mixed solution is 1:30 to 1:80. In step (2), the mass ratio of the cellulose fiber fabric to the MoS₂ aqueous dispersion is 1:50 to 1:80.

The present invention disclosed a fabric wet power generation material based on molybdenum disulfide obtained by the above preparation method.

The present invention also provided an application of the fabric wet power generation material based on molybdenum disulfide, the material is applied to the preparation of a wet power generation device; and using metal as a negative electrode, the MoS₂ in-situ grown carbonized fabric as a positive electrode, encapsulating to obtain a wet power generation device.

In which encapsulating the fabric wet power generation material using a woven fabric and a polyimide adhesive tape.

The principle of the present invention is to prepare an in-situ growth MoS₂ carbonized fabric and a MoS₂-based conductive cotton fabric by using a hydrothermal method, and then the two fabrics are superimposed to form a double-potential layer, so that under a wet condition, the textile material utilizes the water evaporation as the driven force, and the water molecule migrates in the double-conductive layer to generate a current, achieving self-power generation.

Compared with the prior art, the present invention has the following beneficial effects:

1. In the present invention, an in-situ growth MoS₂ carbonized fabric and a MoS₂-based conductive cotton fabric are prepared by using a hydrothermal method, and a transition metal disulfide nanomaterial with a three-dimensional microchannel structure is constructed at a nanoscale after superposition, so that relatively large moisture conductivity and electrical conductivity are ensured in the structure; and meanwhile, a large number of pore channels existing in the three-dimensional structure shorten the ion transmission distance, thereby improving the power generation performance of the material.

2. According to the present invention, a molybdenum disulfide-based loaded carbonized silk fabric and a conductive cellulose fiber fabric are used to prepare a water-induced power generation device having a power output of 30 mW/cm²; and a molybdenum disulfide composite fully-flexible textile is used, which can be prepared in a large area.

3. The technical solution of the present invention has the characteristics of simple and rapid preparation process and high yield, and is beneficial to industrial production and application in the field of flexible intelligent textiles.

### BRIEF DESCRIPTION OF THE DRAWINGS

FIG. 1 is an SEM image of a silk fiber of a MoS₂ in-situ grown carbonized fabric according to Embodiment 1 of the present invention;

FIG. 2 is an SEM image of a cotton fiber of a MoS₂-based conductive cellulose fiber fabric according to Embodiment 1 of the present invention;

FIG. 3 is a schematic structural diagram of a wet power generation device according to Embodiment 1 of the present disclosure.

In the figure, 1, a non-woven fabric; 2, a MoS₂ in-situ grown carbonized fabric; 3, a MoS₂-based conductive cellulose fiber fabric; 4, an aluminum electrode; and 5, polyimide.

### DETAILED DESCRIPTION OF THE INVENTION

The technical solution of the present invention is further described below with reference to the accompanying drawings and specific embodiments.

### Embodiment 1

2.5 g of silk fabric is washed and dried, placed in a tubular furnace, and argon gas is introduced to exhaust air, and carbonization treatment is performed for 180 min at a temperature of 1250° C.; 0.3 g of anhydrous sodium molybdate and 0.8 g of L-cysteine are accurately weighed, added into 100 ml of deionized water, and configured into a mixed solution; putting the silk fabric with an area of 4*10 cm² into the prepared mixed solution, wherein the mass ratio of the fabric to the mixed solution is 1:60, fully stirring, transferring into a polytetrafluoroethylene high-pressure reactor, and reacting for 10 h under the condition that the temperature is 200° C. and the pressure is 3 MPa; fully washing and drying the reacted product to obtain an MoS₂ in-situ grown carbonized fabric.

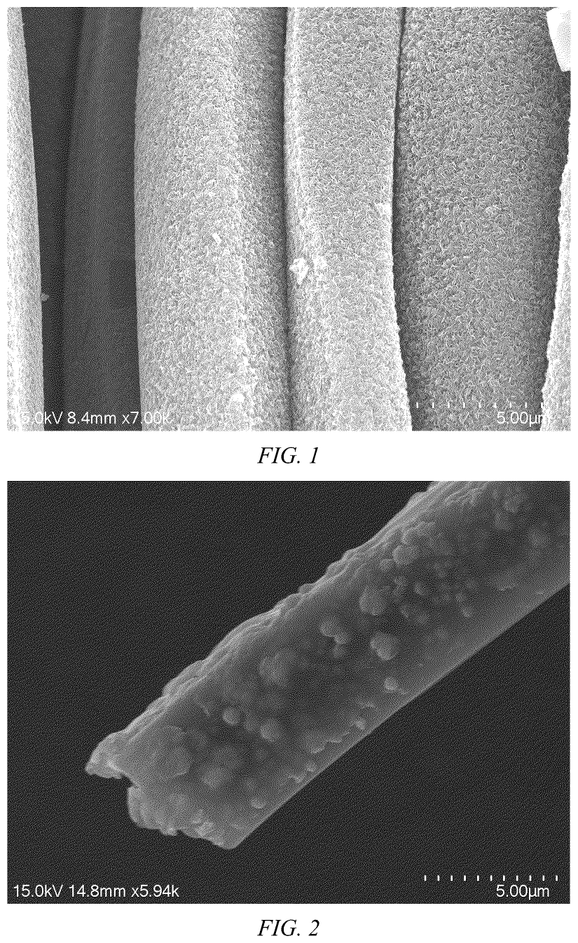

Referring to FIG. 1, which is an SEM image of a silk of the MoS₂ in-situ grown carbonized fabric prepared in this embodiment: FIG. 1 shows that molybdenum disulfide is uniformly grown on the surface of a carbonized silk, and a plurality of tiny nano-channels are formed on the surface of the molybdenum disulfide.

Taking 1.6 M n-butyllithium 8 mL in a flask, adding 300 mg of bulk MoS₂, performing water bath exfoliation treatment at 60° C. for 10 h under an argon condition, then performing centrifugal separation, fully washing with n-hexane, dispersing the washed powder in water to prepare a concentration of 1 mg/mL, performing ultrasonic treatment for 1 h, and performing centrifugation at 3000 r/min for 10 min to obtain a MoS₂ sheet material; taking 0.2 g of MoS₂ sheet layer material, ultrasonically dispersing the MoS₂ sheet layer material in 50 ml of water, and 2 5 g of cotton fabric is immersed in, the liquid rate is kept to be 100% by rolling, and the cotton fabric is baked at high temperature for 10 min at a temperature of 135° C. then 6 ml of polyacrylamide solution is spin-coated at 2000 r/min, and dried to obtain the MoS₂-based conductive cotton fabric.

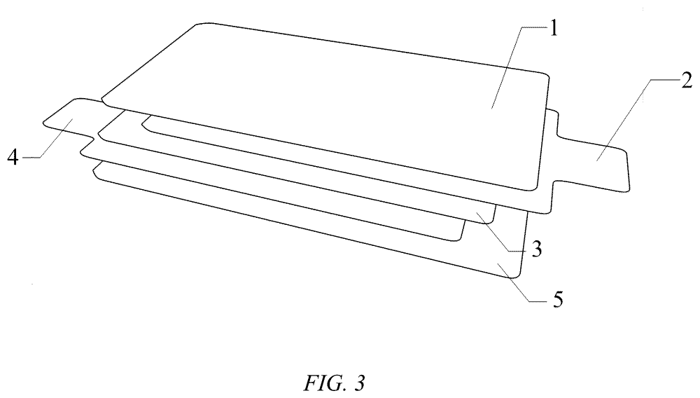

Referring to FIG. 2, which shows a SEM image of cotton fibers in a MoS₂-based conductive cotton fabric prepared in this embodiment, and FIG. 2 shows that the surface of the cotton fabric fiber is covered by a molybdenum disulfide sheet layer material and polyacrylamide.

The obtained two materials are cut longitudinally and superimposed to obtain a molybdenum disulfide-based fabric wet power generation material.

The prepared wet power generation material of the fabric is made of metal as the negative electrode, the MoS₂ in-situ grown carbonized fabric as the positive electrode, encapsulated using the non-woven fabric and the polyimide adhesive tape to obtain the flexible wet power generation device, and the single power generation unit is about 1*2.5 cm².

Referring to FIG. 3, which is a schematic structural diagram of a wet power generation device provided by the present embodiment, the aluminum electrode 4 is disposed on a lower layer of the MoS₂ conductive cotton fabric 3, the MOS₂ conductive cotton fabric is superimposed on the upper surface of the MoS₂ in-situ grown carbonized fabric to form a positive electrode, the top layer is made of a non-woven fabric 1, and the bottom is encapsulated with a polyimide 5.

Upon detection, a single power generation unit of about 1*2.5 cm² provided by the present embodiment is wetted by 0.5 mL of tap water, the generated power generation current is about 0.28 mA, the power reaches 30 mW/cm², and the time can reach more than 3 hours.

According to the technical solution provided in this embodiment, three wet power generation devices are prepared, and the power generation voltage generated after the three power generation units are connected in series is about 2.1 V, and the time is more than 10 hours.

### Embodiment 2

10.0 g of silk fabric is washed and dried, placed in a tubular furnace and filled with argon to exhaust air, and carbonized at 1300° C. for 180 min; 0.6 g of anhydrous sodium molybdate and 1.6 g of L-cysteine are accurately weighed; adding the two into 200 ml of deionized water; putting the carbonized silk with a size of 4*10 cm into the prepared solution, fully stirring, transferring into a polytetrafluoroethylene high-pressure reactor, and reacting for 10 h under the condition of 220° C. and a pressure of 4 MPa; and ultrasonically and fully washing the reacted product, and drying to obtain the in-situ growth MoS₂ carbonized silk fabric.

Taking 16 mL of 1.6 M n-butyllithium in a flask, adding 600 mg of commercial buck MoS₂, stripping for 15 h in a water bath at 60° C. under argon, then centrifuging, washing with n-hexane, dispersing the washed powder in water at a ratio of 1 mg/mL, performing ultrasonic treatment for 2 h, and centrifuging at 3000 r/min for 10 min to obtain a MoS₂ sheet material; and taking 0.2 g of MoS₂ sheet material and dissolving in 50 mL of aqueous solution, and 5 g of cotton fabric is immersed in, the liquid rate is kept to be 110% by rolling, and baked at high temperature for 5 min at a temperature of 140° C., drying to obtain conductive MoS₂ fabric, then 6 ml of polyacrylamide solution is spin-coated on it at 4000 r/min, and dried to obtain the MoS₂-based polyacrylate conductive cotton fabric.

The obtained textile material is cut and longitudinally stacked, a metal is used as the negative electrode, a carbonized fabric is grown in-situ by using a metal as a negative electrode, and a MoS₂ in-situ grown carbonized fabric as the positive electrode, encapsulated using the non-woven fabric and the polyimide adhesive tape to obtain the flexible wet power generation device.

### Embodiment 3

2.5 g of silk fabric is washed and dried, placed in a tubular furnace and filled with argon to exhaust air, and carbonized at 1250° C. for 180 min; 0.3 g of anhydrous sodium molybdate is accurately weighed; accurately weighing 0.8 g L-cysteine; adding the two to 100 ml of deionized water; putting 4*10 cm of carbonized silk into the prepared solution, fully stirring, and then transferring to a polytetrafluoroethylene high-pressure reactor, and reacting for 12 h at 200° C. and under a pressure of 3 MPa; washing and drying the reacted product to obtain an in-situ growth MoS₂ carbonized silk fabric; and taking 8 mL of 1.6M of n-butyllithium in a flask, adding 300 mg of commercial bulk MoS₂, stripping for 10 h in a water bath at 60° C. under argon, washing with n-hexane, dispersing the washed powder in water to prepare a concentration of 1 mg/mL, and centrifuging at 3000 r/min after ultrasonic for 1 h to obtain the MoS₂ sheet material; 0.4 g of MoS₂ sheet material is taken and dissolved in 100 mL of aqueous solution, and immersing 2.5 g of viscose fabric in it, keeping the liquid rate to be 100% by rolling, baking at 140° C. for 5 min, spin-coating 6 ml of polyacrylate solution at 3000 r/min, and drying to obtain a MoS₂-based conductive viscose fabric; and cutting the obtained textile material longitudinally, and packaging with a metal as a negative electrode, with a non-woven fabric and a polyimide adhesive tape to obtain the flexible wet power generation device.

### Embodiment 4

10.0 g of silk fabric is washed and dried, placed in a tubular furnace and filled with argon to exhaust air, and carbonized at 1300° C. for 180 min; accurately weighing 0.6 g of anhydrous sodium molybdate and 1.6 g of L-cysteine; adding the two to 200 ml of deionized water; putting 4*10 cm of carbonized silk into a prepared solution, fully stirring and then transferring into a polytetrafluoroethylene high-pressure reactor, and reacting for 10 h at 220° C. and under a pressure of 4 MPa; and washing the reacted product to obtain an in-situ growth MoS₂ carbonized silk fabric.

Taking 16 mL of 1.6 M of n-butyllithium in a flask, adding 600 mg of commercial buck MoS₂, stripping for 15 h in a water bath at 60° C. under argon, then centrifuging, washing with n-hexane, dispersing the washed powder in water to a ratio of 2 mg/mL, performing ultrasonic treatment for 2 h, and centrifuging at 2000 r/min for 10 min to obtain a MoS₂ sheet material; 0.2 g of MoS₂ sheet material is taken and dissolved in 50 mL of aqueous solution, and 2.5 g of the viscose fabric is immersed for 20 min, the liquid rate is kept at 110% by rolling, and baked at a high temperature of 140° C. for 5 min, 6 ml of polyacrylate solution is spin-coated at 4000 r/min, and dried to obtain the MoS₂/polyacrylate conductive viscose fabric.

The obtained textile material is cut and longitudinally stacked, a metal is used as a negative electrode, and a carbonized fabric is grown in situ by using a metal as a positive electrode, and a non-woven fabric and a polyimide adhesive tape are packaged to obtain the flexible wet power generation device.

What we claim is:

1. A preparation method of a fabric wet power generation material based on molybdenum disulfide, characterizing in comprising the following steps:
(1) washing and drying the silk fabric, and carbonizing it in an argon atmosphere at a temperature of 900-1500° C. for 90-180 minutes; dissolving anhydrous sodium molybdate in deionized water, adding L-cysteine powder into the anhydrous sodium molybdate solution according to a molar ratio of anhydrous sodium molybdate to L-cysteine of 1:2.5-1:3.0, and fully dissolving to obtain a mixed solution; adding the carbonized silk fabric into the mixed solution, stirring for 1-2 h, then placing the silk fabric in a high-pressure reactor, reacting for 10-24 h at a temperature of 200-250° C. and a pressure of 1-4 MPa, and washing and drying to obtain an MoS₂ in-situ grown carbonized fabric;
(2) adding bulk MoS₂ to the n-butyllithium solution according to a mass ratio of 15:1-18:1, and dealing with water bath exfoliation treatment for 10-15 h under an argon atmosphere at a temperature of 60-80° C., then performing centrifugal separation; washing with n-hexane and dispersing the washed powder in water at a concentration of 0.5-5 mg/mL, performing ultrasonic dispersion treatment for 1-2 h, and then performing centrifugal separation at a rotational speed of 2000-3000 r/min to obtain a MoS₂ sheet layer material, which is then configured to be an MoS₂ aqueous dispersion of 0.01-0 03 M; placing the cellulose fiber fabric in the MoS₂ aqueous dispersion for 10-60 min, keeping the liquid rate at 80-120% by rolling, baking for 3-15 min at a temperature of 130-150° C., spin-coating a polyacrylamide solution at a rotational speed of 2000-5000 r/min, and drying to obtain a MoS₂-based conductive cellulose fiber fabric;
(3) superposing the MoS₂ in-situ grown carbonized fabric obtained in step (1) and the MoS₂-based conductive cellulose fiber fabric obtained in step (2) to obtain a fabric wet power generation material based on molybdenum disulfide.

2. The preparation method of the fabric wet power generation material based on molybdenum disulfide according to claim 1, wherein in step (1), the mass ratio of the carbonized silk fabric to the mixed solution is 1:30 to 1:80

3. The preparation method of the fabric wet power generation material based on molybdenum disulfide according to claim 1, wherein in step (2), the mass ratio of the cellulose fiber fabric to the MoS₂ aqueous dispersion is 1:50 to 1:80.

4. A fabric wet power generation material based on molybdenum disulfide obtained by the preparation method of claim 1.

5. An application of the fabric wet power generation material based on molybdenum disulfide according to claim 4, characterizing in that: the material is applied to the preparation of a wet power generation device; and using metal as a negative electrode, the MoS₂ in-situ grown carbonized fabric as a positive electrode, encapsulating to obtain a wet power generation device.

6. The application of the fabric wet power generation material based on molybdenum disulfide according to claim 5, wherein encapsulating the fabric wet power generation material using a woven fabric and a polyimide adhesive tape.
